(19) United States
(12) Patent Application Publication
(10) Pub. No.: US 2010/0198629 A1
(43) Pub. Date: Aug. 5, 2010

(54) Motor vehicle valuation system and method with data filtering, analysis, and reporting capabilities

(75) Inventors: Travis B. Weisleder, Richmond, VA (US); Devin B. Weisleder, Richmond, VA (US)

Correspondence Address: MINTZ LEVIN COHN FERRIS GLOVSKY & POPEO, ONE FINANCIAL CENTER, BOSTON, MA, 02111, US

(73) Assignee: Vuenu Media, LLC, Richmond, VA (US)

(21) Appl. No.: 12/322,441

(22) Filed: Feb. 2, 2009

(51) Int. Cl. G06Q 50/00

(52) U.S. Cl. 705/7; 705/306

(57) ABSTRACT

A motor vehicle valuation system and method with data filtering, analysis, and reporting capabilities is provided. For example, motor vehicle registration data, pricing data, and auction data may be processed in order to identify one or more types of motor vehicles (e.g., by make, model, year, and trim) for which a particular dealership is likely to generate a gross profit within that dealer's territory. The system may report this information to the dealership electronically, for example, within an interactive interface such as a web page.

### FIELD OF THE INVENTION

Embodiments of the present invention relate generally to systems and methods for valuing motor vehicles and, more particularly, to motor vehicle valuation systems and methods with data filtering, analysis, and reporting capabilities.

### BACKGROUND OF THE INVENTION

Motor vehicles are only worth what consumers are willing to pay for them. For example, consumers may be willing to pay a premium for trucks or sports utility vehicles in territories with rough terrain. Attitudes of consumers towards different makes and models of vehicles could also vary regionally and may also affect valuation. The book value of a motor vehicle (e.g., used car) does not capture all of this information. Thus, irrespective of its book value and the price at which a dealer is willing to sell it, a motor vehicle could remain indefinitely within a dealer's inventory if consumer demand is lacking. Traditionally, dealers of motor vehicles have lacked an objective tool for valuing motor vehicles within their territories.

In view of the foregoing, it would be desirable to provide systems and methods for valuing motor vehicles, for example, to identify the motor vehicles most or least likely to generate a profit within a dealer's territory.

### SUMMARY OF THE INVENTION

Embodiments of the present invention relate to systems and methods for valuing motor vehicles. In some embodiments, a computer system is provided that processes motor vehicle registration data to identify one or more types of motor vehicles sold within a territory (e.g., one or more zip codes, cit(ies), state(s), etc.) associated with a motor vehicle dealership. Alternatively or additionally, the system processes (i) motor vehicle pricing data to identify book prices corresponding to types of motor vehicles (e.g., as identified in the registration data) and (ii) motor vehicle auction data to identify auction prices corresponding to the types of motor vehicles. Based on the book prices and auction prices, the computer system generates a report with at least one valuation of a motor vehicle, which may be tailored to the dealer's territory. The computer system may provide the report to the dealership electronically, for example, in an interactive interface such as a web page, by email, or by facsimile.

For example, in some embodiments, the computer system may identify and report one or more types of motor vehicles (e.g., by make, model, year, and/or trim or by segment such as “SUV-Lower Mid Range,” “Pickup Full Size” or “Van-Mini”) for which a particular dealership is likely to generate a gross profit within that dealer's territory. In some embodiments, the potential gross profit for a particular type of motor vehicle may be determined as the book price minus an auction price for that type of motor vehicle.

In some embodiments, the auction price for a type of motor vehicle may be the average auction price of all the motor vehicles sold at auction corresponding to that type (e.g., excluding “salvage” or “as-is” auctions). In some embodiments, the computer system may filter the auction data such that only auction prices for motor vehicle auctions having occurred within the dealer's territory are utilized in determining the average auction price.

In some embodiments, the book price for a type of motor vehicle may be determined based on the average mileage of all the motor vehicles sold at auction corresponding to that type, a base book price for that type of motor vehicle, and at least one mileage adjustment factor. If the average mileage for that type of motor vehicle is above or below an expected mileage, the computer system will decrease or increase the base book price for that type of vehicle by an amount indicated in the at least one mileage adjustment factor. In some embodiments, if the average mileage for that type of motor vehicle is within an expected mileage, or if the computer system does not consider mileage in determining the book price, the computer system may set the book price to be the base book price.

In other embodiments of the present invention, the computer system may identify and report one or more types of motor vehicles that demonstrate the potential for a loss (e.g., within the territory of the dealership) and/or the vehicles for which a valuation has changed and the magnitude of such change relative to a prior report. Such reports may be based on motor vehicle registration data, pricing data, auction data, and/or other data.

The foregoing and other features, aspects, and advantages of the present invention will be more apparent from the following detailed description, which illustrates exemplary embodiments of the present invention.

### BRIEF DESCRIPTION OF THE DRAWINGS

For a better understanding of the present invention, reference is made to the following description, taken in conjunction with the accompanying drawings, in which like reference characters refer to like parts throughout, and in which:

FIG. 1 is a block diagram of a motor vehicle valuation system with data filtering, analysis, and reporting capabilities in accordance with an embodiment of the present invention; and

FIG. 2 is a flowchart of illustrative stages involved in valuing motor vehicles in accordance with an embodiment of the present invention.

### DETAILED DESCRIPTION OF THE INVENTION

The following description focuses on an illustrative application of the present invention to a motor vehicle valuation system and method with data filtering, analysis, and reporting capabilities. In other embodiments, aspects of the present invention described herein can be applied in other contexts with respect to valuing real estate, collectibles (e.g., art and/or memorabilia), goods having value in resale and/or secondary markets, and/or in other contexts.

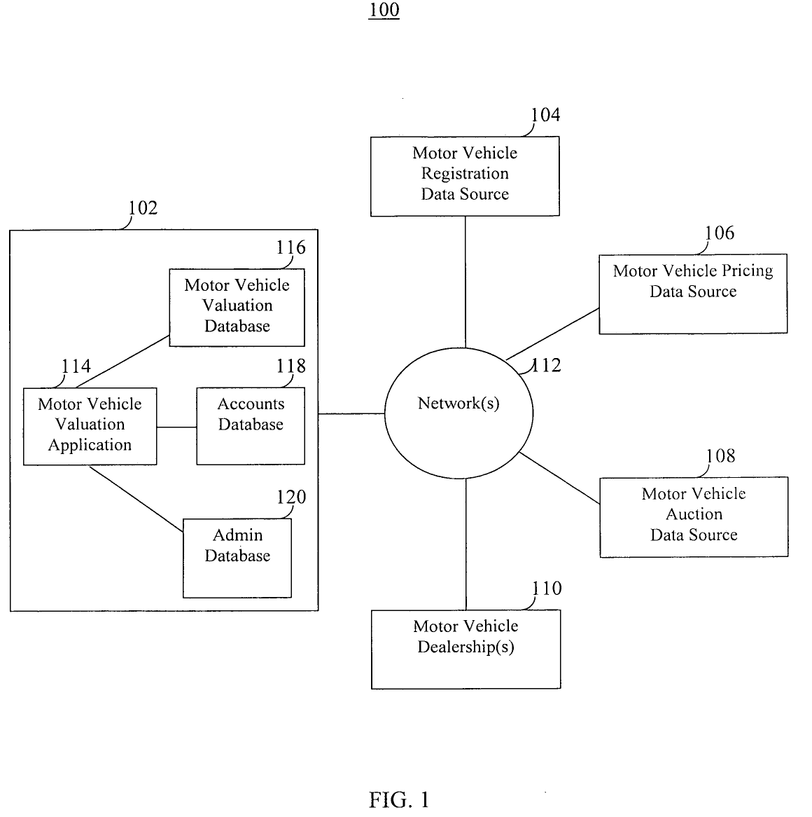

FIG. 1 is a block diagram of a system 100 for valuing motor vehicles (e.g., cars, trucks, motorcycles, etc.) in accordance with an embodiment of the present invention. System 100 includes motor vehicle valuation system 102, motor vehicle registration data source(s) 104, motor vehicle pricing data source(s) 106, motor vehicle auction data source(s) 108, and motor vehicle dealership(s) 110, some or all of which may communicate over a network or networks 112 such as, for example, the internet. Each of motor vehicle valuation system 102, vehicle registration data source(s) 104, pricing data source(s) 106, auction data source(s) 108, and/or motor vehicle dealership(s) 110 may be in electrical communication with network(s) 112 via a suitable communications capability such as, for example, a cable or satellite connection, a local area network (“LAN”), any other suitable wired, wireless, or optical connection, or a combination thereof. Motor vehicle valuation system 102 may include motor vehicle valuation application 114, motor vehicle valuation database 116, accounts database 118 (e.g., for storing account information regarding dealerships 110), and admin database 120.

In some embodiments, system 102 may identify and report one or more types of motor vehicles (e.g., by make, model, year, and/or trim or by segment) for which a particular dealership 110 is likely to generate a gross profit within that dealer's territory. For example, such a report may be based on motor vehicle registration data, pricing data, auction data, and/or other data received and/or processed by system 102. Alternatively or additionally, system 102 may receive and/or process data identifying a territory of dealership 110 (e.g., the dealer's zip code plus associated zip code(s)) and/or may apply other filtering criteria such as, for example, filters that limit the analysis and/or reporting by system 102 to particular vehicle segment(s) of interest to dealership 110 (e.g., 4-door luxury sedans or utility vehicles) to the exclusion of other vehicle segments and/or to particular lender(s) associated with dealership 110. In some embodiments, system 102 may identify and report one or more types of motor vehicles (e.g., by make, model, year, and/or trim or by segment) that demonstrate the potential for a loss within the territory of dealership 110 and/or the vehicles for which a valuation has changed (e.g., by more than a predetermined dollar amount or percentage) and the magnitude of such change relative to prior report(s). Data for or otherwise relating to such reports may be stored in, for example, database 116.

Motor vehicle valuation application 114 within system 102 may include suitable hardware, software, or both for generating valuations of motor vehicles and/or receiving and responding to requests for motor vehicle valuation data and/or other data from computer(s) associated with motor vehicle dealership(s) 110 such as, for example, computers belonging to employees of dealership 110 having accounts (e.g., usernames and passwords) with system 102. For example, in some embodiments, motor vehicle valuation application 114 may include one or more processors and/or servers, for example, configured to receive and respond to hypertext transfer protocol (HTTP) or hypertext transfer protocol over secure socket layer (HTTPS) requests from the computers associated with motor vehicle dealerships 110. Alternatively or additionally, motor vehicle valuation application 114 may communicate with and receive data from data sources 104, 106, and 108 and/or other data sources. Data provided by application 114 to the computers associated dealership(s) 110 in response to such requests may be displayed in, for example, one or more web pages renderable by a browser operating on such computers. In other embodiments, motor vehicle valuations generated by valuation application 114 may be sent to recipients by email or facsimile. Typically, multiple motor vehicle dealerships 110 and associated computers will be included in system 100 although only one dealership 110 has been shown in FIG. 1 to avoid over-complicating the drawing.

Data source 104 may store and provide system 102 with access to registration data for motor vehicles including, for example, vehicle identification number (VIN), lien holder name (e.g., lender such as a bank), vehicle segment, dealership corporate name, zip code, make, model, mileage, year, trim, and/or other registration data. For example, in some embodiments, data source 104 may be the Experian AutoCount database or other database that provides system 102 with access to motor vehicle registration data. Such data may be the same or similar to the data compiled by the Department of Motor Vehicles (DMV) of, for example, one or more (e.g., all) of the 50 United States. System 102 may communicate electronically with registration data source 104 according to any suitable protocol and with any suitable frequency or occurrence. For example, valuation application 114 within system 102 may receive (e.g., download) updates from data source 104 on a monthly or other periodic (e.g., daily) basis or in real time (e.g., in response to requests from dealerships 110) in order to receive data regarding new motor vehicle registrations. In another approach, valuation application 114 may receive (e.g., download) updates from data source 104 in response to a notification from data source 104 indicating the availability of updates. In some embodiments, system 102 may communicate electronically with multiple data sources 104 such as, for example, the DMVs of some or all of the 50 United States or subdivisions thereof. The motor vehicle registration data may be received by system 102, for example, via a suitable web service, eXtensible markup language (XML), file transfer protocol (FTP), or other delivery mechanism. In some embodiments, motor vehicle registration data may be uploaded to system 102 (e.g., database 116) from a data storage medium such as, for example, a hard drive or compact disc received from, for example, Experian, DMV(s), and/or other data provider(s).

Data source 106 may store and provide system 102 with access to pricing data for motor vehicles including, for example, the book value of makes, models, years, trims, and/or mileages of motor vehicles. For example, in some embodiments, data source 106 may be a database that is administered by NADA Guides or Kelly Blue Book, or other provider(s) of vehicle pricing data. Traditionally, lenders (e.g., banks) may use such book value data to determine maximum loan amounts for different types of motor vehicles. System 102 may communicate electronically with pricing data source 106 according to any suitable protocol and with any suitable frequency or occurrence. For example, valuation application 114 within system 102 may download updates from pricing data source 106 on a monthly or other periodic (e.g., daily) basis or in real time (e.g., in response to requests from dealerships 110) in order to receive data regarding motor vehicle pricing. In another approach, valuation application 114 may download updates from data source 106 in response to a notification from data source 106 indicating the availability of updates. In some embodiments, valuation application 114 may communicate electronically with multiple data sources 106 such as, for example, multiple databases administered by NADA Guides, Kelly Blue Book, and/or other provider(s) of pricing data. Valuation application 114 may communicate with or utilize data from different data sources 106 depending on, for example, the particular dealership(s) 110 and associated territories for which valuation application 114 is valuing motor vehicles. For example, system 102 may store data (e.g., in database 118) identifying which pricing data to use when system 102 generates valuation reports for dealerships 110 located in or associated with particular territories. The motor vehicle pricing data may be received by system 102, for example, via a suitable web service, eXtensible markup language (XML), file transfer protocol (FTP), or other delivery mechanism. In some embodiments, motor vehicle pricing data may be uploaded to system 102 (e.g., database 116) from a data storage medium such as, for example, a hard drive or compact disc received from NADA Guides, Kelly Blue Book, and/or other provider(s) of pricing data.

Data source 108 may store and provide system 102 with access to auction data for motor vehicles including, for example, the actual or average purchase prices of makes, models, years, trims, and/or mileages of motor vehicles obtained at motor vehicle auctions (e.g., nationally, within a particular territory, or corresponding to particular auction site(s)). Alternatively or additionally, the same or different data source(s) 108 may provide data indicating the types and quantities of vehicles (e.g., by make, model, year, trim, and/or mileage) which will be available at future auctions and the locations of such auctions, for example, in the particular territories associated with dealerships 110. For example, in some embodiments, data source 108 may be a database that is administered by AuctionNet and/or other provider(s) of motor vehicle auction data such as Manheim, ADESA, Servenet, and/or CarMax. System 102 may communicate electronically with auction data source 108 according to any suitable protocol and with any suitable frequency or occurrence. For example, valuation application 114 within system 102 may download updates from auction data source 108 on a monthly or other periodic (e.g., daily) basis or in real time (e.g., in response to requests from dealerships 110) in order to receive auction data regarding motor vehicles. In another approach, valuation application 114 may download updates automatically from data source 108 in response to notifications from data source 108 indicating the availability of updates. In some embodiments, valuation application 114 may communicate electronically with multiple data sources 108 such as, for example, multiple databases administered by AuctionNet, Manheim, ADESA, Servenet, CarMax, motor vehicle auction sites (e.g., in different territories), and/or other provider(s) of motor vehicle auction data. Valuation application 114 may communicate with or utilize auction data from different data sources 108 depending on, for example, the particular dealership(s) 10 and associated territories for which valuation application 114 is valuing motor vehicles. For example, system 102 may store data (e.g., in database 118) identifying which auction data to use when system 102 generates valuation reports for dealerships 110 located in or associated with particular territories. The motor vehicle auction data may be received by system 102, for example, via a suitable web service, eXtensible markup language (XML), file transfer protocol (FTP), or other delivery mechanism. In some embodiments, motor vehicle auction data may be uploaded to system 102 (e.g., database 116) from a data storage medium such as, for example, a hard drive or compact disc received from AuctionNet, Manheim, ADESA, Servenet, CarMax, motor vehicle auction site(s) in different territories, and/or other provider(s) of motor vehicle auction data.

Database 116 may store motor vehicle valuation data generated by system 102 for one or more dealerships 110. Alternatively or additionally, database 116 may store motor vehicle registration data, pricing data, auction data, and/or other data received from, for example, data sources 104, 106, and/or 108, and/or filtered subsets thereof. In some embodiments, database 116 may store data from the commercially-available Melissa Data database or other database which identifies lists of related zip codes. For example, starting with the zip code within the physical address of a motor vehicle dealership 110, valuation application 114 may query the zip code database (e.g., some or all of which may be stored in database 116 and/or be accessible to application 114 via network(s) 112) to identify the set of zip code(s) that, including the dealer's zip code, defines the dealer's territory.

Alternatively or additionally, database 116 may store data from the commercially-available NADA VIN Prefix database or other database that associates vehicle identifiers such as VINs with, for example, the trim of such vehicles (e.g., base model, luxury version, sport version, etc.). For example, starting with the VIN for a motor vehicle identified in the registration data received from data source 104, valuation application 114 may query the VIN database (e.g., some or all of which may be stored in database 116 and/or be accessible to application 114 via network(s) 112) to identify the trim of the vehicle. Alternatively or additionally, valuation application 114 may utilize the commercially-available NADA VIN Prefix database or other database that associates vehicle identifiers such as VINs with data regarding the motor vehicles to establish a database (e.g., database 116) in which the data fields corresponding to vehicle attributes (e.g., year, make, model, and/or trim) are displayed in a standardized format. For example, registration data source 104 and/or auction data source 108 may use different naming conventions or formats for data corresponding to the vehicle attributes (e.g., year, make, model, and/or trim). Thus, upon receipt of VIN data by application 114 from data source 104 and/or data source 108, application 114 may submit the VINs to the NADA VIN Prefix database or other database to ensure that the data returned and stored in the database (e.g., database 116) is formatted in a standardized format.

In some embodiments, motor vehicle valuation application 114 may query database 116 in order to retrieve or generate reports for one or more motor vehicle dealerships 110 and/or administrative users of system 102. For example, valuation application 114 may query database 116 in real time in response to requests for motor vehicle valuation data and/or other data from computers associated with dealerships 110. In another approach, system 102 (e.g., application 114) may generate reports for dealerships 110 in advance of electronic requests from dealerships 110, and may retrieve and provide such reports to dealerships 110 electronically in response to such requests. In some embodiments, application 114 may notify dealerships 110 when new reports and/or other data are available for download and/or may provide the reports and/or other data to dealerships 110, for example, by email, messaging to user accounts associated with dealerships 110, via facsimile, and/or in hard copy through the physical mail. In some embodiments, application 114 may provide the reports to dealerships 110 in display formats requested by the dealerships in the electronic requests and/or in default display formats defined by dealership and/or user preferences stored in, for example, database 118. For example, different user accounts associated with the same dealership 110 may have different predefined preferences relating to the format (e.g., content and sort attribute(s)) in which motor vehicle valuation data is to be displayed. In some embodiments, users of system 102 may request customized reports (e.g., customized by content and/or sort attribute(s)), for example, by choosing from selectable option(s) (e.g., check boxes) displayed in an interactive interface (e.g., one or more web pages) provided by valuation application 114.

Database 18 may store information regarding motor vehicle dealerships 110 and/or associated user accounts. For example, for each dealership 110, database 118 may store the corporate (legal) name of the dealership 110 which typically corresponds to the name listed in motor vehicle registration data for vehicles sold by that dealer, trade name corresponding to the name under which dealership 110 conducts business (DBA), dealership group name (if the dealership is part of larger organization), franchises at the dealership (e.g., Ford, Chevy, etc.), physical address (e.g., including zip code), billing/mailing address, and/or contact or other information for person(s) associated with the dealership such as a main contact, secondary contact, used vehicle manager, billing contact, general manager, and/or owner. For one or more of such persons, database 118 may store a username and password for providing access to system 102, person name, telephone number, mobile phone number, facsimile number, email address, and/or other information.

In some embodiments, database 118 may store dealership and/or associated user preferences that affect the manner in which system 102 generates and/or provides reports regarding motor vehicle valuation data and/or other data to dealerships 110 and/or associated users. For example, database 118 may store data identifying preferred or excluded vehicle segments such as, for example, an attribute of dealership 110 or an associated user indicating that “4dr Luxury” vehicles are not to be listed in default reports for that dealer or user since it does not expect to sell into that market. In other examples, database 118 may store preferences related to preferred or excluded franchises, program enrollment (e.g., data indicating what features of system 102 are accessible to dealership 110 and/or associated user(s)), and/or preferred, excluded, or otherwise associated lenders (e.g., lenders with which a dealership 110 has done or is desirous of doing business with). In yet another example, database 118 may store data indicating the territory of dealership 110 such as, for example, the zip code(s), geographical identifiers, and/or other data identifying a designated marketing area (DMA) of or area(s) of interest (e.g., cit(ies), count(ies), state(s), etc.) to dealership 110 (e.g., regardless of whether the dealership 110 is physically located or currently doing business in such territory in whole or in part). For example, in some embodiments, the territory of dealership 110 may be determined by querying zip code data (e.g., Melissa Data stored in database 116) with the zip code in the dealer's physical address. In some embodiments, one or more of these preferences may be used to filter the data received (e.g., from data sources 104, 106, and/or 108) or otherwise processed by valuation application 114 to a relevant subset of data. In some embodiments, dealerships 110 and/or associated users may have the option to override such preferences (e.g., defaults) and to view customized reports, for example, by making selections within an interactive interface (e.g., one or more web page(s)) provided by valuation application 114.

In some embodiments, database 118 may store other account information for dealerships 110 including, for example, start date and off date of service, where the off date being can be set automatically as 30 days from the start date unless service is renewed. In other examples, database 118 may store billing preferences, credit card information, a pricing schedule for data and/or services provided by system 102 to dealership 110 and/or associated users, and dealer and/or user status (e.g., active, 14 Day free trial, inactive, prospect, hot prospect, warm prospect, cold call, call back, locked out, non-payment, card declined, canceling). Alternatively or additionally, database 118 may store information identifying the sales representative(s) associated with each dealership 110 and/or the commission provided to such sales representatives (e.g., dollar amount, percentage, whether such commission is a one-time or recurring fee, etc.).

Database 120 may store information relating to one or more administrative users of system 102 having permissions, for example, to search, create, edit, and/or delete some or all of the data within system 102. For example, such administrative users may have user names and passwords that allow them to search, create, edit, and/or delete any or all data regarding dealerships 110 and/or associated users (e.g., preferences or billing or contact data stored in database 118), data regarding sales representatives, data received from or relating to data sources 104, 106, and/or 108, and/or interfaces (e.g., web pages) provided by application 114. In some embodiments, application 114 may generate displays of information for display to an administrative user of system 102. Such information displays may be at least partially interactive to allow the administrative user, for example, to search, create, edit, and/or delete the contents described above. For example, within such information displays, the administrative users may be permitted to search, edit, and/or review all available information regarding dealerships 110, for example, by dealership name (full or partial), dealership identification, city, state, zip code, other territorial identifier, and/or dealership username(s). Alternatively or additionally, administrative users may be permitted to search, edit, and/or review data regarding active and/or inactive dealerships and/or associated users, dealerships by location, program, price paid, average revenue per dealership, new dealerships for a current week, month, or other period (e.g., year-to-date), last log-in, program start date, and/or program end date. In some embodiments, database 120 may store data establishing a demonstration account from which sales representatives or administrative users can demonstrate features of system 102 to customers or potential customers. For example, a demonstration account username and password may be provided that provides access to interfaces from which sample reports are generated. In some embodiments, such sample reports may be based on fictitious or old data or masked so as not to reveal valuations of motor vehicles. In some embodiments, as a customer service tool, database 120 may store data establishing permissions for administrative users to log on to system 102 as any specific dealership 110 or associated user in, for example, a separate window that appears on the user's display.

Databases 116, 118, and 120 are only illustrative and any other suitable storage may be provided for storing information accessible to system 102. For example, a single database may be provided within system 102 that combines the functions of databases 116, 118, and 120 and/or such data may be stored remotely from system 102 (e.g., application 114) for access by system 102.

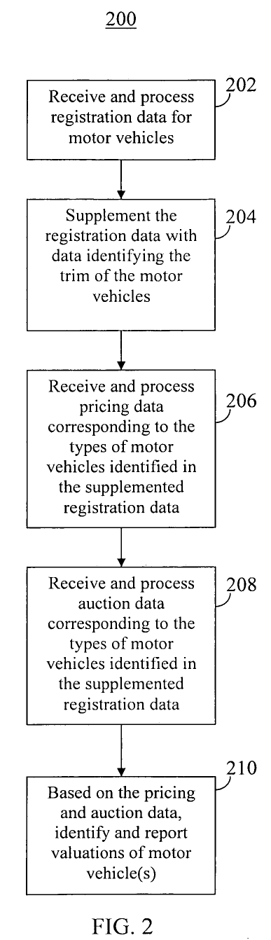

FIG. 2 is a flowchart of illustrative stages involved in valuing motor vehicles in accordance with an embodiment of the present invention. At stage 202, motor vehicle registration data may be received and processed. For example, valuation application may filter the vehicle registration data (e.g., from data source(s) 104) to identify vehicles registered within the territory of a particular dealership 110 as defined by the set of zip code(s) and/or other territorial or geographic identifiers stored in database 118 in association with dealership 110. Alternatively or additionally, other filter(s) may be applied to the registration data at stage 202. For example, valuation application 114 may filter the registration data to identify motor vehicles financed by lender(s) identified in database 118 in association with dealership 110. Other non-limiting examples of filters that may be used to filter the motor vehicle registration data include franchise(s), vehicle segment(s), vehicle year, vehicle mileage, and/or auction location. In other embodiments, stage 202 may be optional such as, for example, when system 102 determines motor vehicle valuations on a national basis or otherwise based on pricing data and auction data and without the use of registration data.

At stage 204, the motor vehicle registration data may be supplemented with, for example, data identifying the trim of each motor vehicle. For example, vehicle identifiers such as VINs in the registration data may be decoded using, for example, a decoding computer program product such as the VIN decoding product referred to as NADA VIN Prefix or by valuation application 114 communicating with or querying another suitable apparatus or database. Optionally, stage 204 may be omitted when, for example, data identifying the trim of each motor vehicle is included within the registration data received and processed at stage 202.

At stage 206, pricing data corresponding to the one or more types of motor vehicles identified in the supplemented registration data (e.g., vehicle types identified by makes, models, years, trims, and/or mileages) may be received and processed. For example, the pricing data for each vehicle type may identify or approximate the maximum loan amount for that vehicle which could be obtained from a lender. For example, system 102 may receive the base book value (e.g., from data source 106) for each type of motor vehicle (e.g., make, model, year, and trim) identified in the supplemented registration data. In addition, in some embodiments, the base book value for each specific type of motor vehicle may be accompanied by mileage adjustment factors for mileage additions and subtractions. For example, such mileage adjustment factors may indicate that the base book value for a vehicle based on its make, model, year, and trim should be increased by $1000 if it is under its expected mileage by 1-10,000 miles, and decreased by $1000 if it is over its expected mileage by 1-10,000 miles.

At stage 208, auction data corresponding to the types of motor vehicle(s) (e.g., make, model, year, and trim) identified in the supplemented registration data may be received and processed. For example, system 102 may receive data (e.g., from data source 108) identifying or approximating the actual or expected auction purchase prices of such types of motor vehicles. In some embodiments, the auction data may be filtered based on territory such that, for example, only auction data from within the same set of zip codes associated with dealership 110 is included in the analysis. In some embodiments, for each vehicle type (e.g., make, model, year, and trim), the actual mileages of the vehicles sold at auction may be received at stage 208 and an average of such mileages may be determined. Alternatively or additionally, an average of the actual auction prices may be determined at stage 208.

At stage 210, based on the pricing and auction data received and/or generated in stages 206 and 208, valuations of motor vehicle(s) may be identified and reported. For example, valuation application 114 may generate a report identifying the type(s) of motor vehicles within the territory of dealership 110 that demonstrate the highest potential for gross profit, which may be determined as the vehicle types demonstrating the largest difference between their book value (e.g., expected maximum loan amount that could be obtained from a lender) and average auction price. For example, in some embodiments, for each vehicle type (e.g., make, model, year, and trim), the book value used within this comparison may be determined by applying the base book value and mileage adjustment factors obtained at stage 206 to the average mileage for the auctioned vehicles of that type obtained at stage 208. For example, if the average mileage of the auctioned vehicles obtained at stage 208 is under the expected mileage for vehicles of that type by 1-10,000 miles, the base book value may be increased by $1000 to determine the book value for use in the comparison at stage 210. In some embodiments, the book value for each vehicle type may be the base book value. Alternatively or additionally, in some embodiments, at stage 210 a report may be provided that identifies vehicle type(s) within the dealer's territory demonstrating the potential for a loss and/or vehicle type(s) for which valuations have changed (e.g., more than a specified amount or percentage) and the amount of such change relative to prior report(s). In some embodiments, one or more reports provided at stage 210 may identify the types of vehicles (e.g., by make, model, year, and/or trim) and quantities of such vehicles which will be available at future auctions and/or the locations of such auctions, for example, within the territory of the dealership 110 for which a report is generated at stage 210. The order of stages 202-210 in FIG. 2 is only illustrative, and these stages, a subset thereof, and/or other stages may be performed in any other suitable order in accordance with various embodiments of the present invention.

Tables 1 and 2 below show illustrative examples of reports that may be generated by motor vehicle valuation application 114 and reported to dealerships 110 and/or associated users according to some embodiments of the present invention. The data provided within and format of these reports is only illustrative. In other embodiments, additional data and/or a subset of this data may be provided by valuation application, for example, in response to requests for motor vehicle valuation data from dealerships 110. The following descriptions correspond to the types of data listed in each of the header columns in Tables 1 and 2:

Rank: current vehicle rank by average potential gross profit (e.g., gross profit determined based on an average of auction purchase prices) in a territory of dealership 110 as of current report (e.g., weekly or monthly, depending on the program or service in which dealership is enrolled).

Previous Rank: previous rank of that specific year, make, model and trim level vehicle in dealership's territory by average potential gross profit (e.g., weekly or monthly).

Color Code Ranking: color-coded (e.g., green or red) arrows indicate an increase or decrease, respectively, in rank from previous week or month. Another color-coded (e.g., yellow) line indicates no change.

Year: indicates the model year of the vehicle. The source of such data may be vehicle registration data source 104.

Make: this is the vehicle make. The source of such data may be data source 104.

Model: this is the model name of the vehicle associated with the year and make of the vehicle. The source of such data may be vehicle registration data source 104.

Trim: this is the specific subset of the particular year, make and model of the vehicle. As described above, the trim of a vehicle may be determined with reference to the NADA VIN Prefix database or other suitable database. In some embodiments, the trim may be derived by taking the book values (e.g., from pricing data source 106) and average auction values (e.g., from auction data source 108) in the dealership's territory of each specific year, make, model and trim level to find the corresponding trim level with the highest average potential gross profit. The trim level with the highest average potential gross profit may be selected as the output.

Average Mileage: this is the average of all the vehicles in dealership's territory of the corresponding year, make, model and trim sold at auction for a given period (e.g., either the previous month or week). The source of such data may be auction data source 108. In Table 2, the mileage categories include the individual vehicle mileage of each vehicle that was sold thru the auction in the dealership's territory. The source of such data used to determine the average mileage may be auction data source 108.

Book Value: this is the specific year, make, model and trim level vehicle value (assuming clean trade-in, no adds or subtractions) for that period (e.g., month) in the dealership's territory. The source of such data may be pricing data source 106 which provides base book values and mileage adjustment factors, as applied to the average mileage for that vehicle type as determined from data obtained from auction data source 108.

Average Auction Value: this is the average vehicle value with the specific year, make, model and trim that has been sold at the auction for the previous period (e.g., either week or month) in that dealership's territory. This value may exclude “salvage” and “as-is” vehicles. The source of such data may be auction data source 108.

Average Potential Gross @100%: this is the difference between the specific vehicle's book value times 100% less the average auction value of the same specific vehicle in dealership's territory.

Color Code: color-coded (e.g., green or red) arrows indicate an increase or decrease, respectively, in dollar amount from previous period (e.g., week or month) of the average potential gross profit of that specific vehicle. Another color-coded (e.g., yellow) line indicates no change.

Change from Last Month: this is the actual dollar change in average potential gross profit from previous period (e.g., week or month) for that specific vehicle.

Average Potential Gross @120%: this is the difference between the specific vehicle's book value times 1.2 less the average auction value of the same specific vehicle in dealership's territory, which equals 120% of the potential gross profit.

Retail Sold: this is the total number of that specific vehicle (year, make, model and trim) sold in dealership's territory for the previous week or month. The source of such data may be vehicle registration data source 104.

Percent of Segment: this is the total number of that specific make, model, and year vehicle (e.g., trim may be ignored here) sold in the dealership's territory divided by the total number of vehicles sold in that particular segment in the dealership's territory. For example, in row 1 of Table 1, this would be the total number of Ford Five Hundred's divided by the total number of sedans sold in the dealership's territory. The source of such data may be vehicle registration data source 104.

Percent of Total Market: this is the total number of that specific make, model, and year vehicle (e.g., trim may be ignored here) sold divided by the total number of vehicles sold in the dealership's territory for the given period (e.g., weekly or monthly). The source of such data may be vehicle registration data source 104.

Sold thru Auction: this is the total number of that specific year, make, model and trim level vehicle sold thru the auction for the previous period (e.g., week or month) in dealer's region. The source of such data may be auction data source 108 such as, for example, AuctionNet.

Auction Location: this is the location of where that specific year, make, model and trim level vehicle will be sold in the future. Each number will correspond to a specific auction location in that dealership's auction territory. The list of specific auction locations will be provided. The source of such data may be one or more auction data sources 108 such as, for example, Manheim, ADESA, Servenet, and/or CarMax.

Auction Availability: this is the total number of that specific year, make, model and trim level vehicle that will be available at the upcoming auctions in the dealer's territory. The source of such data may be one or more auction data sources 108 such as, for example, Manheim, ADESA, Servenet, and/or CarMax.

Top 5 Lenders: this includes the lenders that the dealer uses that have financed the most number of the specific year, make and model vehicle in the dealership's territory. The source of such data may be vehicle registration data source 104

Number Financed: this includes the total number of the specific year, make and model vehicles financed by each one of the Top 5 Lenders. The source of such data may be vehicle registration data source 104.

TABLE 1

| | [symbol] | | | | | | | | | Average | Average |
|---|---|---|---|---|---|---|---|---|---|---|---|
| | Previous | | | | | | | Average | Book | Auction | Potential |
| Rank | Rank | | Year | Make | Model | Trim | Segment | Mileage | Value | Value | Gross@100% |
| 1 | 5 | [symbol] | 2005 | Ford | Five Hundred | Limited AWD | SDN | 40,025 | $10,500 | $8,000 | $2,500 |
| 2 | 1 | [symbol] | 2006 | Misu | Outlander | SE 2WD | Utility | 42,255 | $10,550 | $8,200 | $2,750 |
| 3 | 3 | [symbol] | 2007 | Dodge | Caravan | 5XT | Caravan | 35,000 | $10,175 | $7,500 | $2,575 |
| 4 | | | | | | | | | | | |
| . . . | | | | | | | | | | | |
| 30 | | | | | | | | | | | |

| | | Change | Average | | | Percent | Sold | | |
|---|---|---|---|---|---|---|---|---|---|
| | | From Last | Potential | Retail | Percent | of Total | thru | Auction | Auction |
| Rank | | Month | Gross@120% | Sold | of Segment | Market | Auction | Location | Availability |
| 1 | [symbol] | +400 | $4,950 | 56 | 10% | 2% | 8 | 1, 4, 5 | 30 |
| 2 | [symbol] | −200 | $4,940 | 40 | | | 12 | | |
| 3 | [symbol] | +100 | $4,710 | 32 | | | 9 | | |
| 4 | | | | | | | | | |
| . . . | | | | | | | | | |
| 30 | | | | | | | | | |

TABLE 2

| | | | | | | | | | Average |
|---|---|---|---|---|---|---|---|---|---|
| [symbol] | | | | | | | Average | Book | Auction |
| Rank | Rank | Year | Make | Model | Trim | Segment | Mileage | Value | Value |
| 1 | 5 | 2005 | Ford | Five Hundred | Limited AWD | SDN | 40,023 | $10,800 | $8,000 |
| | | | | | | | >100k | 0 | |
| | | | | | | | 100-80k | 1 | |
| | | | | | | | 80-60k | 1 | |
| | | | | | | | 60-40k | 3 | |
| | | | | | | | 40-20k | 3 | |
| | | | | | | | <20k | 0 | |

| | | Average | | Change | Average | | | Number |
|---|---|---|---|---|---|---|---|---|
| [symbol] | | Potential | | From Last | Potential | Top 5 | Number | thru |
| Rank | Rank | Gross@100% | | Month | Gross@120% | Lenders | Financed | Auction |
| 1 | 5 | $2,800 | [symbol] | +400 | $4,960 | Ford Motor | 10 | 8 |
| | | | | | | Credit | | |
| | | | | | | Wells Fargo | 8 | |
| | | | | | | Wachevia | 5 | |
| | | | | | | Henrico CU | 3 | |
| | | | | | | SunTrust | 2 | |

Table 3 below shows another illustrative example of a report that may be generated by motor vehicle valuation application 114 and reported to dealerships 110 and/or associated users according to some embodiments of the present invention. This report may provide a listing of the top 5 vehicles financed by lenders for a previous period (e.g., monthly or weekly) within a territory of dealership 110. The source of such data may be vehicle registration data source 104. In some embodiments, a report may be provided that is similar to the report shown in Table 3 but that includes an additional column indicating: (i) for each lender and vehicle type listed, the percentage of all vehicles financed by that lender corresponding to that vehicle type (e.g., 24% of vehicles financed by lender GMAC were 2007 Chevrolet Malibu vehicles); and/or (ii) for each vehicle type listed, the percentage of all vehicles sold during that period (regardless of lender) corresponding to that vehicle type (e.g., 5% of all the vehicles sold within that period were 2006 Jeep Cherokee vehicles).

TABLE 3

| Year | Make | Model | Lender | Number |
|---|---|---|---|---|
| 2007 | Chevrolet | Malibu | GMAC | 26 |
| | | | Drive | 18 |
| 2008 | Ford | Mustang | Americredit | 15 |
| | | | Wells Fargo | 11 |
| 2006 | Jeep | Cherokee | Consumer Portfolio Services | 10 |
| | | | Chase | 6 |
| 2007 | Ford | Focus | Ford Motor Credit | 36 |
| | | | First Market Bank | 22 |
| 2006 | Chevrolet | Cobalt | Wells Fargo | 23 |
| | | | BB&T | 17 |

Table 4 below shows yet another illustrative example of a report that may be provided by motor vehicle valuation application 114 in accordance with embodiments of the present invention. This report identifies the top 5 used vehicle segments (e.g., Pickup Full Size) in terms of potential gross profit determined as the average gross profit of all vehicles in the segment, where gross profit is the book value minus the auction value as described above in connection with FIG. 2. Total units sold is the total number of units sold in that segment for a given period (e.g., weekly or monthly) within the territory of the dealership 110. The percentage of total is the percentage of that segment's vehicles sold verses the total number of vehicles sold for that period within the dealership's territory.

TABLE 4

| | Potential | | |
|---|---|---|---|
| | Gross | Total | % of |
| Segment | Profit | Units Sold | Total |
| Mid Range Standard | $4,158 | 500 | 15% |
| Pickup Full Size | $3,250 | 350 | 11% |
| Van - Mini | $3,126 | 250 | 9% |
| SUV - Entry | $2,956 | 200 | 8% |
| SUV - Lower Mid Range | $2,862 | 185 | 7% |

Thus it is seen that systems and methods are provided for valuing motor vehicles. Although particular embodiments have been disclosed herein in detail, this has been done by way of example for purposes of illustration only, and is not intended to be limiting with respect to the scope of the appended claims, which follow. In particular, it is contemplated by the applicant that various substitutions, alterations, and modifications may be made without departing from the spirit and scope of the invention as defined by the claims. Other aspects, advantages, and modifications are considered to be within the scope of the following claims. The claims presented are representative of the inventions disclosed herein. Other, unclaimed inventions are also contemplated. The applicant reserves the right to pursue such inventions in later claims.

Insofar as embodiments of the invention described above are implementable, at least in part, using a computer system, it will be appreciated that a computer program for implementing at least part of the described methods and/or the described systems is envisaged as an aspect of the present invention. The computer system may be any suitable apparatus, system or device, electronic, optical or a combination thereof. For example, the computer system may be a programmable data processing apparatus, a general purpose computer, one or more processors, an optical computer or a microprocessor. The computer program may be embodied as source code and undergo compilation for implementation on a computer, or may be embodied as object code, for example.

It is also conceivable that some or all of the functionality ascribed to the computer program or computer system aforementioned may be implemented in hardware, for example by means of one or more application specific integrated circuits and/or optical elements. Suitably, the computer program can be stored on a carrier medium in computer usable form, which is also envisaged as an aspect of the present invention. For example, the carrier medium may be solid-state memory, optical or magneto-optical memory such as a readable and/or writable disk for example a compact disk (CD) or a digital versatile disk (DVD), or magnetic memory such as disk or tape, and the computer system can utilize the program to configure it for operation. The computer program may also be supplied from a remote source embodied in a carrier medium such as an electronic signal, including a radio frequency carrier wave or an optical carrier wave.

What is claimed is:

1. A computer system for valuing motor vehicles, comprising:
a motor vehicle valuation application configured to:
process motor vehicle registration data to identify, within the motor vehicle registration data, data corresponding to one or more types of motor vehicles sold within a territory associated with a motor vehicle dealership;
process motor vehicle pricing data to identify book prices corresponding to the one or more types of vehicles identified in the motor vehicle registration data;
process motor vehicle auction data to identify auction prices corresponding to the one or more types of motor vehicles identified in the motor vehicle registration data; and
based on the book prices and auction prices, generate a report comprising at least one valuation of a motor vehicle pertaining to the territory associated with the motor vehicle dealership.

2. The computer system of claim 1 wherein the motor vehicle valuation application configured to process motor vehicle auction data is configured to process motor vehicle auction data to identify auction prices, within the territory associated with the motor vehicle dealership, corresponding to the one or more types of motor vehicles identified in the motor vehicle registration data.

3. The computer system of claim 1 wherein the motor vehicle valuation application configured to generate a report comprising at least one valuation of a motor vehicle is configured to:
determine, for each of the one or more types of motor vehicles, a potential gross profit for that type of motor vehicle within the territory associated with the motor vehicle dealership, wherein the potential gross profit comprises the book price for that type of motor vehicle minus the auction price for that type of motor vehicle; and
generate a report identifying the potential gross profit corresponding to at least one type of motor vehicle within the territory associated with the motor vehicle dealership.

4. The computer system of claim 3 wherein the motor vehicle valuation application is further configured to:
process motor vehicle pricing data to identify book prices corresponding to the one or more types of vehicles identified in the motor vehicle registration data, wherein the book price for each type of motor vehicle includes a base book price plus at least one mileage adjustment factor.

5. The computer system of claim 4 wherein the motor vehicle valuation application is further configured to:
process the motor vehicle auction data to identify mileages of motor vehicles sold at auction corresponding to the one or more types of motor vehicles identified in the motor vehicle registration data; and
for each type of the one or more types of motor vehicles:
average the mileages of the motor vehicles sold at auction corresponding to that type of motor vehicle to determine an average mileage;
average the auction prices of the motor vehicles sold at auction corresponding to that type of motor vehicle to determine an average auction price;
based on the average mileage, and the base book price and at least one mileage adjustment factor for that type of motor vehicle, determine the book price for that type of motor vehicle; and
determine the potential gross profit for that type of motor vehicle within the territory of the motor vehicle dealership as the book prices for that type of motor vehicle minus the average auction prices.

6. The computer system of claim 1 wherein the motor vehicle valuation application is further configured to:
process auction data to identify a quantity of motor vehicles corresponding to the at least one type of motor vehicle that will be available for purchase in one or more future motor vehicle auctions and a location corresponding to the one or more future motor vehicle auctions; and
provide within the report data identifying the quantity of motor vehicles corresponding to the at least one type of motor vehicle which will be available for purchase in one or more future motor vehicle auctions and the location corresponding to the one or more future motor vehicle auctions.

7. The computer system of claim 1, wherein each of the one or more types of motor vehicles comprises a make, a model, and a year of a motor vehicle.

8. The computer system of claim 7, wherein each of the one or more types of motor vehicles further comprises a trim of the motor vehicle.

9. The computer system of claim 8, wherein the motor vehicle valuation application is further configured to:
for each motor vehicle within the registration data corresponding to the one or more types of motor vehicles:
identify a vehicle identifier; and
determine a trim of the motor vehicle based on the vehicle identifier.

10. The computer system of claim 1, wherein the territory of the motor vehicle dealership comprises a zip code of the motor vehicle dealership.

11. The computer system of claim 1, wherein the territory of the motor vehicle dealership further comprises a plurality of zip codes associated with the zip code of the motor vehicle dealership.

12. A computer-implemented method for valuing motor vehicles, comprising:
processing with one or more processors motor vehicle registration data to identify, within the motor vehicle registration data, data corresponding to one or more types of motor vehicles sold within a territory associated with a motor vehicle dealership;
processing with the one or more processors motor vehicle pricing data to identify book prices corresponding to the one or more types of vehicles identified in the motor vehicle registration data;
processing with one or more processors motor vehicle auction data to identify auction prices corresponding to the one or more types of motor vehicles identified in the motor vehicle registration data; and
based on the book prices and auction prices, generating with the one or more processors a report comprising at least one valuation of a motor vehicle pertaining to the territory associated with the motor vehicle dealership.

13. The computer-implemented method of claim 12 wherein processing motor vehicle auction data comprises processing with the one or more processors motor vehicle auction data to identify auction prices, within the territory associated with the motor vehicle dealership, corresponding to the one or more types of motor vehicles identified in the motor vehicle registration data.

14. The computer-implemented method of claim 12 wherein generating a report comprising at least one valuation of a motor vehicle comprises:
determining with the one or more processors, for each of the one or more types of motor vehicles, a potential gross profit for that type of motor vehicle within the territory associated with the motor vehicle dealership, wherein the potential gross profit comprises the book price for that type of motor vehicle minus the auction price for that type of motor vehicle; and
generating with the one or more processors a report identifying the potential gross profit corresponding to at least one type of motor vehicle within the territory associated with the motor vehicle dealership.

15. The computer-implemented method of claim 14 further comprising:
processing with the one or more processors motor vehicle pricing data to identify book prices corresponding to the one or more types of vehicles identified in the motor vehicle registration data, wherein the book price for each type of motor vehicle includes a base book price plus at least one mileage adjustment factor.

16. The computer-implemented method of claim 15 further comprising:
processing with the one or more processors the motor vehicle auction data to identify mileages of motor vehicles sold at auction corresponding to the one or more types of motor vehicles identified in the motor vehicle registration data; and
for each type of the one or more types of motor vehicles:
averaging with the one or more processors the mileages of the motor vehicles sold at auction corresponding to that type of motor vehicle to determine an average mileage;
averaging with the one or more processors the auction prices of the motor vehicles sold at auction corresponding to that type of motor vehicle to determine an average auction price;
based on the average mileage, and the base book price and at least one mileage adjustment factor for that type of motor vehicle, determining with the one or more processors the book price for that type of motor vehicle; and
determining with the one or more processors the potential gross profit for that type of motor vehicle within the territory of the motor vehicle dealership as the book prices for that type of motor vehicle minus the average auction prices.

17. The computer-implemented method of claim 12 further comprising:
processing with the one or more processors auction data to identify a quantity of motor vehicles corresponding to the at least one type of motor vehicle that will be available for purchase in one or more future motor vehicle auctions and a location corresponding to the one or more future motor vehicle auctions; and
with the one or more processors, providing within the report data identifying the quantity of motor vehicles corresponding to the at least one type of motor vehicle which will be available for purchase in one or more future motor vehicle auctions and the location corresponding to the one or more future motor vehicle auctions.

18. The computer-implemented method system of 12, wherein each of the one or more types of motor vehicles comprises a make, a model, and a year of a motor vehicle.

19. The computer-implemented method of claim 18, wherein each of the one or more types of motor vehicles further comprises a trim of the motor vehicle.

20. The computer-implemented method of claim 19 further comprising:
for each motor vehicle within the registration data corresponding to the one or more types of motor vehicles:
identifying with the one or more processors a vehicle identifier; and
determining with the one or more processors a trim of the motor vehicle based on the vehicle identifier.

21. The computer-implemented method of claim 12, wherein the territory of the motor vehicle dealership comprises a zip code of the motor vehicle dealership.

22. The computer-implemented method of claim 12, wherein the territory of the motor vehicle dealership further comprises a plurality of zip codes associated with the zip code of the motor vehicle dealership.

23. A computer readable medium comprising computer program instructions recorded thereon for performing the method comprising:
processing motor vehicle registration data to identify, within the motor vehicle registration data, data corresponding to one or more types of motor vehicles sold within a territory associated with a motor vehicle dealership;
processing motor vehicle pricing data to identify book prices corresponding to the one or more types of vehicles identified in the motor vehicle registration data;
processing motor vehicle auction data to identify auction prices corresponding to the one or more types of motor vehicles identified in the motor vehicle registration data; and
based on the book prices and auction prices, generating a report comprising at least one valuation of a motor vehicle pertaining to the territory associated with the motor vehicle dealership.

24. Apparatus for valuing motor vehicles, comprising:
means for processing motor vehicle registration data to identify, within the motor vehicle registration data, data corresponding to one or more types of motor vehicles sold within a territory associated with a motor vehicle dealership;
means for processing motor vehicle pricing data to identify book prices corresponding to the one or more types of vehicles identified in the motor vehicle registration data;
means for processing motor vehicle auction data to identify auction prices corresponding to the one or more types of motor vehicles identified in the motor vehicle registration data; and
means for based on the book prices and auction prices, generating a report comprising at least one valuation of a motor vehicle pertaining to the territory associated with the motor vehicle dealership.

25. A computer system for valuing motor vehicles, comprising:
a motor vehicle valuation application configured to:
process motor vehicle pricing data to identify book prices corresponding to one or more types of vehicles;
process motor vehicle auction data to identify auction prices corresponding to the one or more types of motor vehicles; and
based on the book prices and auction prices, generate a report comprising at least one valuation of a motor vehicle.
